(19) United States
(12) Patent Application Publication
(10) Pub. No.: US 2011/0121105 A1
(43) Pub. Date: May 26, 2011

(54) MULTI-POSITIONAL HANDHELD FLUID POWERED SPRAY DEVICE WITH DETACHEABLE ACCESSORIES

(75) Inventors: Brian P. Moriarty, Maple Valley, WA (US); Edward A. Uhl, Seattle, WA (US); Brett J. Carter, Monroe, WA (US)

(73) Assignee: H2O INNOVATIONS, INC., Seattle, WA (US)

(21) Appl. No.: 12/623,394

(22) Filed: Nov. 21, 2009

(51) Int. Cl. B05B 9/01

(52) U.S. Cl. 239/526

(57) ABSTRACT

A handheld fluid powered spray device that is capable of receiving detachable accessories, that provides a power output source available to power detachable accessories, that has a compact arrangement, can be used in multiple positions during operation or non-operation and that evacuates the powering fluid efficiently to maximize and sustain output power of the device.

### BACKGROUND OF THE INVENTION

This invention relates to a handheld fluid powered spray device having detachable accessories that can be operated in multiple positions during operation or non-operation of the device while efficiently evacuating the powering fluid to maximize and sustain output power of the device.

As described in U.S. Pat. No. 6,595,440 (“Moriarty”), conventional fluid spray devices are in widespread use in many household, commercial and industrial applications. For example, in the household, spray devices are in use in kitchens for spraying items in the kitchen sink and in bathrooms for washing the bathroom shower or tub. In the kitchen, such spray devices may be a separate component commonly known as a side spray unit or may be integrated into the faucet itself, which can be extracted from the faucet housing and used in the same manner a side sprayer is used. There are also many spray devices designed for adaptation to garden hoses for watering plants and the like, washing cars, driveways and the outside of a house or building. Spray devices are also used for a variety of different cleaning applications in industrial and commercial settings such as restaurants or factories.

Many conventional fluid spray devices perform only the function of spraying fluid in a single pattern. Some conventional fluid spray devices permit the user to change the spray pattern of the spray device by providing a multi-ported or variable patterned spray head.

Another feature employed in many spray devices is the use of a reservoir in the spray device itself or attached to the spray device that permits the introduction of liquid cleaning agents such as soap into the fluid stream. Other spray devices use fluid as power to drive a transmission for rotating a brushing device fixed to the end of the spray device. Such transmissions are typically turbine like devices, which are rotated by fluid jets directed at blades on the turbine. The turbine is in most cases coupled to a gearing arrangement that in turn rotates the brushing device. Some fluid powered spray devices are designed to evacuate the fluid from the chamber holding the turbine and gear arrangement while other spray devices allow the turbine and gear arrangement to remain submerged in the chamber. If the fluid is not evacuated from such chamber in an efficient and sustainable manner or if the turbine is submerged, then the resulting output power of the gear arrangement will be hindered and the output power of the spray device will not be maximized.

A majority of spray devices utilizing turbines or the like have the drawback of being very large and cumbersome because they are designed for applications such as washing floors, automobiles, boats, buildings and cannot be fully operated with a single hand. Although such devices must typically be held by both hands of the user to operate, they are not handheld devices within the sense of the present invention because the user cannot operate all features of the device with the single hand holding the device. As spray devices become smaller and more compact the ability to evacuate the fluid from the chamber that houses the turbine in an efficient and sustainable manner becomes more important and more difficult.

Another drawback of spray devices utilizing turbines or the like is that they are configured such that the position of the member that houses the rotating turbine is fixed to a single position or fixed to a single position during operation. A user may desire to vary the position or angle of the cleaning device to match the form or contour of the apparatus being cleaned at the same time the user is operating the cleaning device. In addition, the user may need to reach an area inside of the apparatus to be cleaned that may be difficult to reach without an extended or variable position. Known fluid powered spray devices do not solve those problems because they are single bodied devices that only provide a single position during operation. In such known devices, the fluid channels that provide a pathway to power the turbines and/or to spray are static and do not provide a pathway to accommodate multiple positions or angles to match the form or contour of the apparatus being cleaned during operation or non-operation of the device.

Another problem not solved by conventional spray devices utilizing turbines or the like is the problem of efficiently evacuating the fluid used to power the turbine from a compact turbine area such that the turbine does not lose power from the hydrodynamic resistance of the fluid after it deflects onto the turbine, floods or submerges the turbine. If the rotation speed of the turbine in conventional spray devices is hindered, then the output power of a drive mechanism, such as a gear system, coupled to the turbine will also be hindered and the user of the device will not receive the benefit of maximum power.

Accordingly, it is desirable to have a handheld fluid powered spray device that is capable of receiving detachable accessories, that provides a power output source available to power detachable accessories, that has a compact arrangement, that can be used in multiple positions within a range of three hundred and sixty degrees during operation or non-operation and that efficiently evacuates the powering fluid in a manner that maximizes and sustains output power of the device.

### BRIEF SUMMARY OF THE INVENTION

In accordance with the principles of the present invention, a handheld fluid powered spray device is provided with a fluid powered output source to power detachable accessories, that can be used in multiple positions within a range of three hundred and sixty degrees during operation or non-operation and that evacuates the powering fluid in an efficient and sustainable manner to maximize output power.

### BRIEF DESCRIPTION OF THE DRAWINGS

In the drawings:

FIG. 1 illustrates a three dimensional cross sectional view of the body of the present invention;

FIGS. 2-4 illustrate three dimensional cross sectional views of components of a fluid spray device constructed in accordance with the principles of the present invention;

FIGS. 5-6 illustrate two dimensional views of possible operating positions of the present invention;

FIG. 7 illustrates a two dimensional frontal view of components of a fluid spray device constructed in accordance with the principles of the present invention;

FIG. 8 illustrates a three dimensional cross sectional view of components of a fluid spray device constructed in accordance with the principles of the present invention; and

FIG. 9 illustrates a three dimensional cross sectional view of a rotating detachable accessory constructed in accordance with the principles of the present invention.

### DETAILED DESCRIPTION OF THE INVENTION

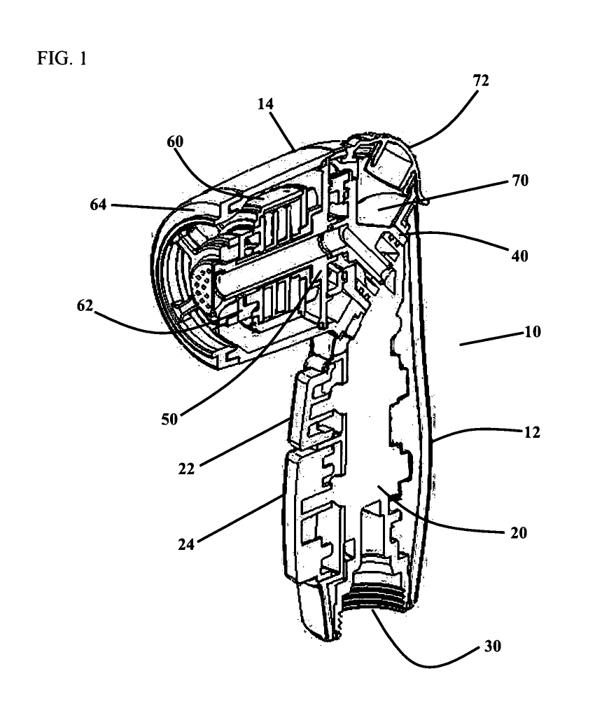

Referring first to FIG. 1, a three dimensional view of a multi-positional body 10 is shown having control housing 12 and transmission housing 14. Control housing 12 is shown with valve body 20, spray trigger 22, turbine trigger 24 and hose adaptor 30. Transmission housing 14 is shown with rotating joint 40, turbine housing 50, transmission assembly 60, drive coupler 62, drive hub 64, agent reservoir 70 and reservoir cap 72.

Hose adaptor 30 is constructed with well known thread and sealing techniques such that the pressurized fluid delivered from the pressurized fluid source (not shown) will not leak when connected to hose adaptor 30. Those skilled in the art will readily recognize that hose adaptor 30 can be configured to offer varying degrees of tilt and/or rotational motion. For example, hose adapter 30 could be constructed of well known sealed ball and socket technology (not shown) to provide a user with both rotational and tilt motion of the hose (not shown) within the hose adaptor. Using such technique, hose adapter 30 may be rotated 360 degrees and tilted or swiveled 15 to 45 degrees from its normal position. Hose adapter 30, control housing 12, transmission housing 14 or control valve 20 may house an optional inline pressure regulator (not shown) to regulate the pressure of the fluid being supplied to the device.

In operation, hose adapter 30 will be attached to a fluid delivery system such as a flexible hose (not shown) that will in-turn be attached to a pressurized fluid supply source such as household plumbing or the like (not shown). If a spray device of the present invention is used with a faucet and the pressurized fluid source is shared between the faucet and the spray device, then a standard off-the-shelf shut-off accessory may be applied to, or integrated into, the exit port of the faucet such that fluid will be conserved during operation of the present invention and such that all pressure from the pressurized fluid source is available to the spray device. If the present invention is utilized in a commercial or industrial context, then standard off-the shelf fittings and accessories can be used by one familiar with standard plumbing techniques to make the appropriate connections between the spray device and the pressurized fluid source.

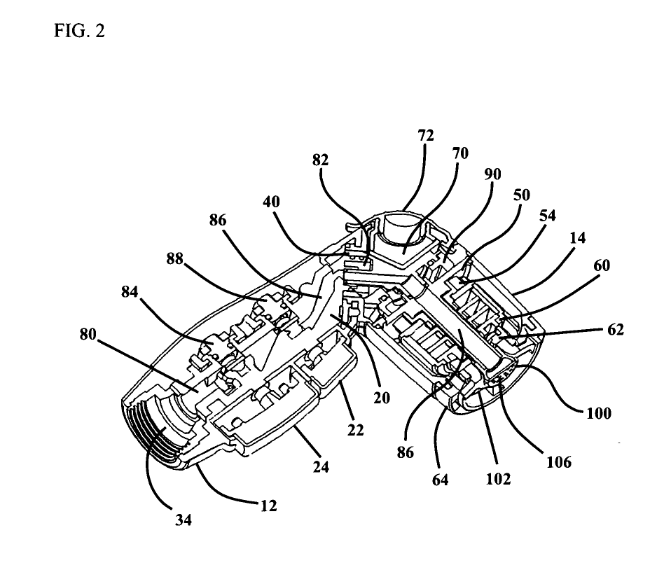

Turning now to FIG. 2, a three dimensional cross sectional view of the details of a fluid spray device constructed in accordance with the principles of the present invention is shown.

Control housing 12 is shown with valve body 20 having fluid supply channel 80, turbine channel 82, turbine valve 84, spray channel 86 and spray valve 88. Fluid supply channel 80 is shown connecting to pressurized fluid inlet 34. Valve body 20 is ported using well known methods such that fluid supply channel 80 is ported to turbine valve 84 and spray valve 88. In operation, turbine valve 84 and spray valve 88 are set to the normally off position such that the pressurized fluid from channel 80 cannot pass through the valves until the valves are depressed. When turbine trigger 24 is depressed, turbine valve 84 opens and allows the pressurized fluid to pass through turbine valve 84 to turbine channel 82. Similarly, when spray trigger 22 is depressed, spray valve 88 opens and allows the pressurized fluid to pass through spray valve 88 to spray channel 86.

In a preferred embodiment of the present invention, turbine valve 84 and spray valve 88 are variable on/off valves set to the normally off position. For example, if a user applies a small amount of pressure to turbine trigger 24, a small amount of pressurized fluid will flow through turbine valve 84. Similarly, if a user applies an increased amount of pressure to turbine trigger 24, an increased amount of pressurized fluid will flow through turbine valve 84. No flow will occur in either valve until pressure is applied to the trigger. One skilled in the art will readily recognize that turbine valve 84 and/or spray valve 88 may also be constructed of multi-position valves, rocker valves or configured using readily available valve latching techniques such that the user can temporarily lock either or both valves on the open position for extended use.

FIG. 2 also shows a three dimensional cross sectional view of transmission housing 14 with rotating joint 40, turbine housing 50, turbine 54, transmission assembly 60, drive coupler 62, drive hub 64 and pressure chamber 90. Rotating joint 40 is shown with turbine channel 82 ported into pressure chamber 90.

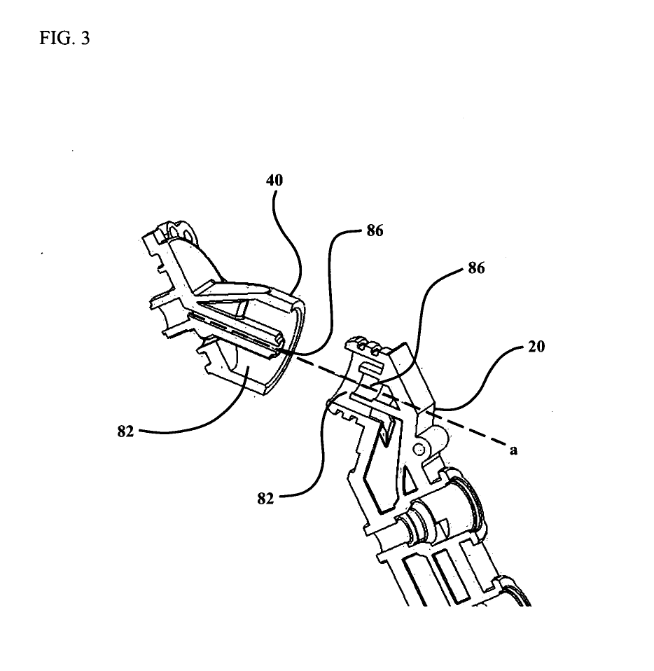

Turning now to FIG. 3, a three dimensional cross sectional view of the details of valve body 20 and rotating joint 40 are shown. Turbine channel 82 and spray channel 86 are shown constructed in a manner to provide separate fluid supply channels as the pressurized fluid is transferred from control housing 12 to transmission housing 14. Those skilled in the art will readily recognize that valve body 20 may be constructed to provide a plurality of channels that can be ported from valve body 20 to rotating joint 40. For example, a pressurized or non-pressurized reservoir (not shown) located in control housing 12 may be used to introduce separate fluids such as cleaning agents or air into transmission housing 14 in addition to spray and turbine channels.

Rotating joint 40 is shown with turbine channel 82 and spray channel 86. The inner diameter of spray channel 86 in valve body 20 is sized to fit snugly over the outer diameter of spray channel 86 in rotating joint 40. Similarly, the outer diameter of turbine channel 82 in valve body 20 is sized to fit snugly inside the inner diameter of turbine channel 82 in rotating joint 40. Using such inner and outer diameter sizing of turbine channel 82 and spray channel 86 and using pressurized fluid sealing techniques such as o-rings (not shown), valve body 20 can be coupled to rotating joint 40 in such a manner that allows the transfer of pressurized fluids through multiple channels without leakage from control housing 12 to transmission housing 14 while also allowing the three hundred and sixty degree rotation of rotating joint 40 about the center axis a of valve body 20 before, during and after such fluid transfer.

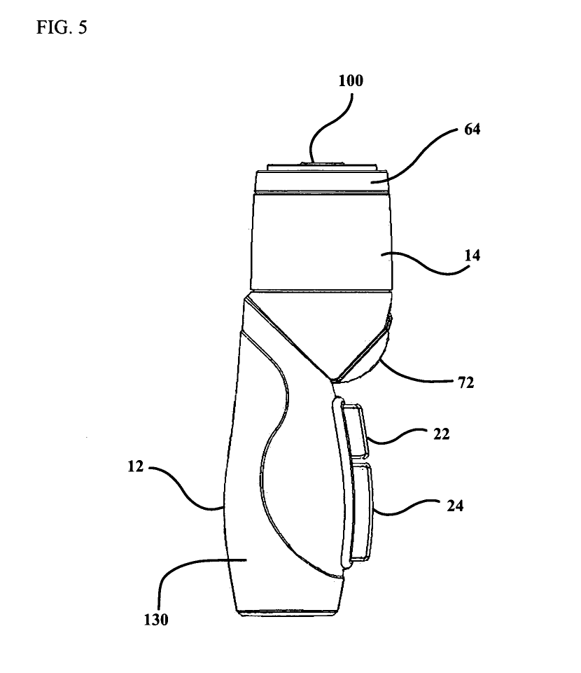

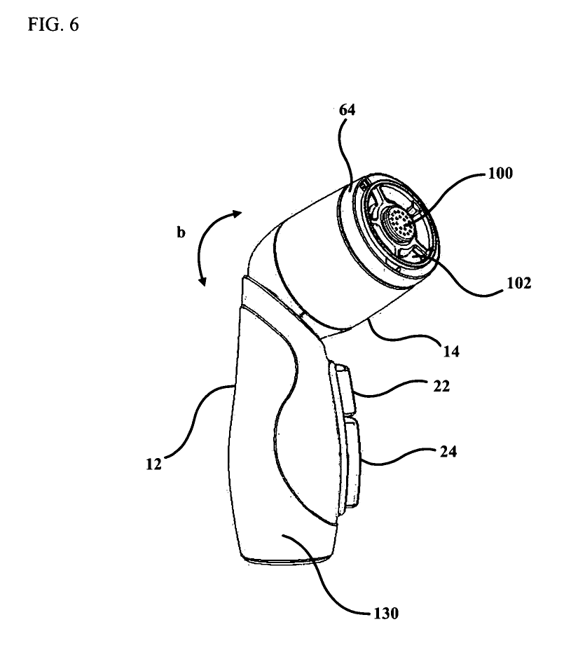

Turning now to FIG. 5 and FIG. 6, two dimensional views of the present invention are shown with control housing 12, transmission housing 14 and grip 130. Transmission housing 14 and control housing 12 are positionally and dimensionally matched such that transmission housing 14 can be rotated about control housing 12 in the same manner rotating joint 40 rotates about valve body 20 (as shown by arrow b in FIGS. 5 and 6) and in a such manner that rotating joint 40 will be rotatably secured to valve body 20. Control housing 12 and transmission housing 14 may also include mated detents (not shown) such that the control housing and transmission housing can be seated or temporarily secured in multiple pre-set positions before, during or after transfer of the pressurized fluid from control housing 12 to transmission housing 14. Control housing 12 is shown with rubberized grip 130 that helps the user hold the device in a secure manner. The grip material may be rubber or like material that will maintain durability in a wet environment.

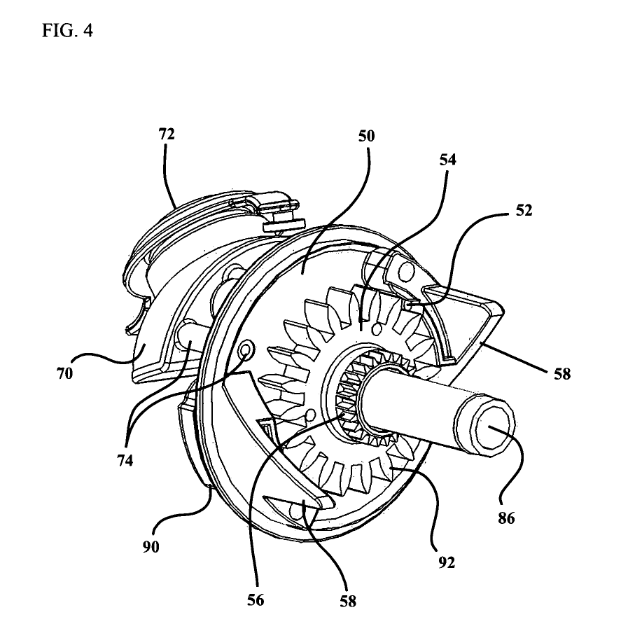

Turning now to FIG. 4, a three dimensional cross sectional view of turbine housing 50, fluid jet ports 52 (only one shown), turbine 54, sun gear 56, ramps 58, spray channel 86 and pressure chamber 90 is shown.

Turbine 54 is a circular device having blades or fins 92 in the outer diameter of the turbine integrated with sun gear 56 such that the sun gear is positioned at the center portion of the turbine. As shown in FIG. 2, turbine 54 and transmission assembly 60 are configured to allow spray channel 86 to pass through the center of the turbine, sun gear and transmission assembly without restricting the rotation of the turbine and sun gear around the outer diameter of spray channel 86 or without restricting the power of transmission assembly. Such configuration also provides a compact design supporting the handheld nature of the present invention.

As pressurized fluid travels from turbine valve 84 through turbine channel 82 to pressure chamber 90 a back pressure is created by the restriction of fluid jets 52 which are open to atmospheric pressure. As shown in FIG. 4 the turbine and fluid jets are spatially arranged in housing 50 such that the fluid stream projected from fluid jets 52 is targeted at blades or fins 92 on turbine 54. The turbine blades or fins may be angled or cupped such that fluid projected from fluid jets 52 rotates turbine 54 and sun gear 56 when it impacts the blades. Fluid jets 52 have hollowed cylindrical inner diameters (not shown) which are sized to project the pressurized fluid onto the blades of turbine 54 in a high velocity compact stream. Fluid jets 52 are also sized to obtain the desired rotational speed and output torque of drive hub 54 with minimal fluid consumption. The hollowed cylindrical inner diameters (not shown) of fluid jets 52 may also be shaped such that the inlet to such inner diameter is larger than the outlet of such inner diameter. In such a shape, the inner diameter is cone shaped, wherein the large end of the cone is located at the fluid inlet. One skilled in the art will readily recognize that the number of jets may be increased or decreased to vary the performance of the turbine 54. An optional filter (not shown) may be placed in the fluid stream prior to the jets such that unwanted particles will not reach and clog the fluid jets.

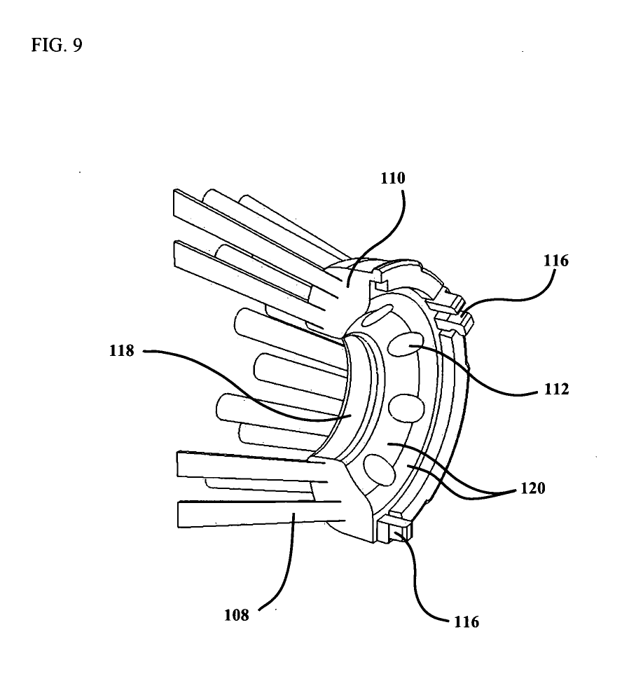

Fluid jets 52, turbine 54 and ramps 58 are configured and arranged to displace and expel the fluid efficiently and to reduce hydrodynamic drag on the turbine. If turbine 54 becomes submerged during operation the output torque and rotational speed will be reduced in proportion to the hydrodynamic drag placed on the turbine. Although performance of the spray device will be hindered in such cases, drive coupler 62 (shown in FIG. 2) will continue to operate in accordance with the principles of the present invention. Ramps 58 reduce hydrodynamic drag on the turbine caused from fluid back spray or deflection after the fluid is expelled from the turbine by directing the fluid away from the turbine towards fluid exit ports 102 (shown in FIG. 2, FIG. 6 and FIG. 8) such that the expelled fluid is quickly and efficiently evacuated from transmission housing 14. Such configuration and arrangement allows turbine 54 to rotate at maximum performance under the then current operating variables such as fluid pressure and allows turbine 54 to sustain such operation without hydrodynamic drag during operation.

In a preferred embodiment of the present invention transmission 60 (shown in FIG. 2) is a sealed unit having a series of planetary gears (not shown) positioned inside of the unit and coupled to sun gear 56. When fluid jets 52 direct the fluid to the blades or fins 92, turbine 54 and sun gear 56 will rotate. Sun gear 56 is coupled to the planetary gears of transmission 60, which are in turn coupled to drive coupler 62 (as shown in FIG. 2). The planetary gears are sized and arranged to provide a rotational speed range of 200 to 300 revolutions per minute (“RPM”) and a torque output of 2 to 5 inch-pounds with a fluid supply pressure of 30 to 60 pounds per square inch (“PSI”). Those skilled in the art will readily recognize that other well known gear configurations and ratios such as spur and pinion gears or worm gears may also be used or that varying the pressure of the fluid supply will vary the RPM and output torque of the device.

Turning now to FIG. 2, transmission 60 is shown coupled to drive coupler 62. Drive coupler 62 is keyed to mate with drive hub 64 such that the drive hub is freely secured to transmission housing 14 using well known low friction bearing techniques. The bearing configuration allows drive hub 64 to rotate freely when driven by drive coupler 62.

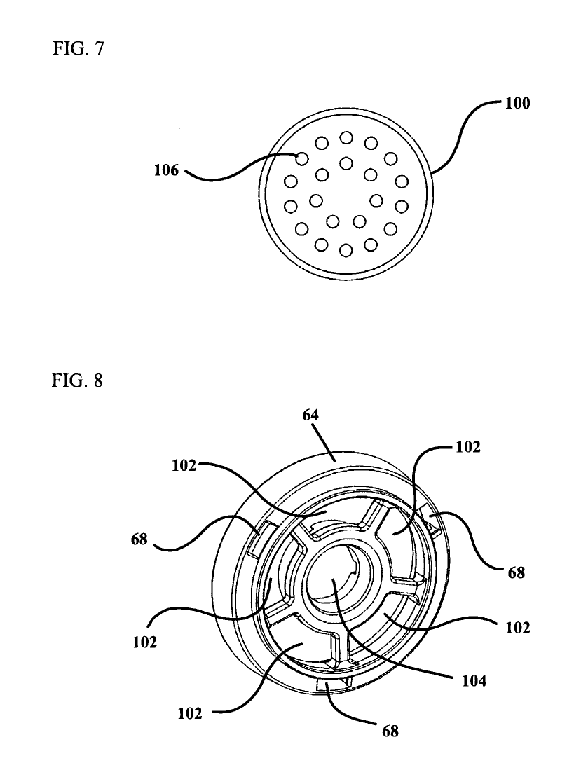

Spray nozzle 100 is shown at the exit of spray channel 86. As the pressurized fluid exits spray channel 86 it passes through diffuser ports 106 of the nozzle and is dispersed in a pattern. Diffuser ports 106 may be arranged to create a spray pattern as can be seen in FIG. 7, for example.

Turning now to FIG. 8, a three dimensional view of drive hub 64 is shown with exit ports 102, spray port 104, and key slots 68. Exit ports 102 are shown on drive hub 64 as slot shaped ports but may also be other geometric shapes such as circular shaped ports. Female keys slots 68 are shaped and positionally and dimensionally aligned to mate with male keys 116 as described below.

Turning back to FIG. 4, agent reservoir 70 is shown having reservoir cap 72 and agent dispersing tube 74. Reservoir cap 72 covers an opening in agent reservoir 70 to allow the user to load agent into reservoir 70. After the reservoir is filled with an agent, reservoir cap 72 seals agent reservoir 70 and prevents leakage of the agent. Reservoir cap 72 is constructed with a durable and flexible material such as rubber, for example, such that pressure from the user's finger can be applied to the outer shell of reservoir cap. The applied pressure on reservoir cap 72 displaces the air between the reservoir cap and the agent (not shown) in reservoir 70 such that the agent is dispersed through disperse tube 74 into or near the fluid being dispersed from fluid jets 52. As the agent (not shown) dispersed from disperse tube 74 is engaged by the fluid expelled from fluid jets 52, the agent will mix with the fluid and exit transmission housing 14 through exit ports 102. For example, if the agent is soap and the fluid is water, then the soap and water will mix to create foam, foam like fluid or a soapy fluid mixture.

Those skilled in the art will readily recognize that agent reservoir 70, reservoir cap 72 and agent dispense tube 74 can be varied to change the amount of agent, timing of the agent dispensed or location of the dispensed agent. For example, agent dispense tube 74 could be configured to dispersed the agent at various locations within the path of the fluid dispersed from fluid jets 52 to create various mixtures or separations of agent and fluid. Those skilled in the art will readily recognize that an agent reservoir could also be included in control housing 12 and channeled to transmission housing 14 and agent disperse tube 74 using the same technique described above for channeling spray channel 86 and turbine channel 82 through rotating joint 40 and using the siphoning technique described in Moriarty. A predetermined amount of agent could also be dispensed using the agent dispensing technique described in Moriarty.

The spray device of the present invention is designed such that the user can easily hold control housing 12, operate turbine trigger 22, operate spray trigger 24, and operate reservoir cap 72 with a single hand. In addition, the user can adjust the position or angle of the transmission housing 14 in multiple positions in a range of three hundred and sixty degrees relative to the control housing, before, during or after any of the operations.

Turning now to FIG. 9, a three dimensional view of a detachable accessory of a fluid spray device constructed in accordance with the principles of the present invention is shown. Attachment base 110 is shown having a series of fluid exit ports 112, bristles 108, spray opening 118, male keys 116 and concentric contour 120. As set forth in the description above regarding exit ports 102, fluid exit ports 112 may be slot shaped ports, having one constant slot or several slots or other geometric shapes.

As fluid or a fluid/agent mixture flows through exit ports 102 (as shown in FIGS. 1, 2, 5 and 6), it will be directed through fluid exit ports 112 for application to bristles 108 or other material used in place of bristles 108 (as described below) and through spray opening 118. In a preferred embodiment of the present invention, bristles 108 are constructed of nylon fibers having flexibility and strength appropriate to withstand scrubbing action caused by the rotation of drive hub 64. Bristles 108 may also be constructed of wire strands using materials such as brass, stainless steel and the like to increase the strength of the bristles for more demanding cleaning or scrubbing applications. Bristles 108 may also be substituted with other materials such as synthetic sponges, abrasive pads and the like. Bristles 108 and attachment base 110 may be constructed to be sanitized with a wash machine or by hand. Such detachable accessories may vary in size, shape, configuration, materials and cleaning medium based on the application.

Keys 116 are positionally and dimensionally matched to fit snugly with key slots 68 (shown in FIG. 8) to provide a detachable locking action of attachment base 110 to drive hub 64. Key slots 116 are shown as “L” shaped but may be of any shape that provides such a detachable locking action.

Spray opening 118 is dimensionally matched to permit the fluid exiting spray port 104 to be dispersed without resistance. Concentric contour 120 is shaped to efficiently evacuate the fluid exiting exit ports 102. Such evacuation will prevent the exiting fluid from deflecting back into the transmission housing and hindering the speed of turbine 54. Ramps 58, the shape of exit ports 102, fluid exit ports 112 and concentric contour 120 provide a configuration and arrangement that allows turbine 54 to rotate at maximum performance under the then current operating variables such as fluid pressure and allows turbine 54 to sustain such operation without hindrance during operation.

In operation of the fluid powered spray device of the present invention, hose adapter 30 is connected to a pressurized fluid source (not shown) such as a household fluid supply line found in most homes. As pressurized fluid enters supply inlet 34 it will travel through fluid supply channel 80 of valve body 20 to pressurize turbine valve 88 and spray valve 84.

Once spray valve 84 is pressurized and the user applies pressure to spray trigger 22, spray valve 84 will open and allow the pressurized fluid to enter channel 86 and pass through valve joint 40 and through the center of pressure chamber 90, turbine 54, sun gear 56 and transmission housing 60 to spray nozzle 100. The pressurized fluid will then exit though spray port 104 in a pattern determined by the arrangement of the diffuser ports 106 on the spray diffuser. The spray pattern will travel through spray opening 118 of attachment base 110. FIG. 7 shows one of numerous spray pattern arrangements for spray nozzle 100.

Once turbine valve 88 is pressurized and the user applies pressure to turbine trigger 24, the pressurized fluid at turbine valve 88 will enter turbine channel 82 and pass through valve joint 40 to supply pressurized fluid to pressure chamber 90. The pressurized fluid in the pressure chamber will be forced through fluid jets 52. Since the inner diameter of fluid jets 52 has a smaller diameter, the pressurized fluid will flow through the fluid jets and will be projected onto the turbine blades 92 in a high velocity compact stream, thus, rotating the turbine. As the fluid is expelled from the turbine blades, the expelled fluid will flow onto ramps 58. As the fluid exits ramps 58, the fluid is directed towards exit ports 102 such that the fluid is evacuated from transmission housing 14 in an efficient and sustaining manner, which minimizes fluid from deflecting on to turbine 54 and causing the turbine to slow in RPM.

As sun gear 56 rotates at the same RPM of turbine 54, the gears (not shown) coupled to the sun gear and located inside of transmission 60 will transfer the rotating energy to drive coupler 62, which will in turn rotate drive hub 64. Drive coupler 62 and drive hub 64 will rotate at an RPM depending on the sizing and arrangement of the gears (not shown) in transmission 60 and the RPM of the turbine. As drive hub 64 rotates, the attachment base 110 will rotate at the same rate.

If agent reservoir 70 contains an agent and the user applies pressure to agent reservoir cap 72, then the agent will be dispensed from agent dispense tube 74 into transmission housing 14 near the fluid being expelled from blades 92 and ramps 58. The agent and fluid mixture will be directed towards exit ports 102 while drive hub 64 rotates.

If attachment base 110 is attached to drive hub 64, then fluid or fluid/agent mixture will flow or drain through exit ports 102, spray port 104, through fluid exit ports 112 through and about bristles 108 and through spray opening 118.

If the user desires to use the spray device of the present invention as described above but also desires to change the relative position of transmission housing 14 to control housing 12 during operation or non-operation, then the user may rotate transmission housing 14 about control housing 12 to obtain the desired positioning in a range of three hundred and sixty degrees. If desired, the user may apply pressure to spray valve 22 and/or turbine valve 24 while also rotating the transmission housing about the control housing such that the fluid exits spray nozzle 100 and/or causes drive hub 64 to rotate as described above.

Thus, providing the user with a handheld fluid powered spray device that is capable of receiving detachable accessories, that provides a power output source available to power the detachable accessories, that has multiple positions during operation or non-operation and that evacuates the powering fluid in an efficient and sustainable manner to maximize power output.

Those skilled in the art will readily recognize that the fluid powered spray device of the present invention may be configured in many embodiments. For example, the fluid powered spray device of the present invention can be integrated (detachably or fixed) into the head of a retractable or non-retractable faucet for use in the kitchen sink, attached to a garden hose for use in outdoor applications, attached to a shower head for use in a bathroom shower or tub or applied in residential, commercial and industrial applications.

The fluid powered spray device of the present invention is constructed using ABS plastics or equivalent plastic materials. However, one skilled in the art will readily recognize that different materials may be used if the spray device of the present invention is intended for use in industrial or commercial applications requiring both internal and external resistance to damaging fluids, materials and environments. Those skilled in the art will also recognize that pressurized air may also be used in the same manner as the pressurized fluid to obtain the same rotation of drive hub 64.

What is claimed is:

1. A fluid powered spray device comprising:
a first body configured to be held by the hand of a user;
a second body rotatably coupled to said first body;
a plurality of channels extending from said first body to said second body;
a plurality of control valves in said first body controlling the delivery of pressurized fluid to said channels;
a turbine in said second body configured to rotate after receiving fluid delivered from one of said channels;
a transmission in said second body, said transmission being coupled to and driven by said turbine;
a rotatable drive hub coupled to and driven by said transmission, said drive hub having fluid exit ports and configured to receive a plurality of detachable accessories; and
a plurality of detachable accessories selectively attachable to said drive hub.

2. The fluid powered spray device of claim 1 having a plurality of ramps in said second body, said ramps configured to expel fluid away from said turbine and towards said fluid exit ports after said fluid is received by said turbine.

3. The fluid powered spray device of claim 2 having a plurality of fluid jets in said second body dispersing fluid delivered from one of said channels to said turbine.

4. The fluid powered spray device of claim 3 having a nozzle in said second body dispersing fluid from one of said channels.

5. The fluid powered spray device of claim 4, wherein said fluid channel to said nozzle extends concentrically through said turbine, though said transmission and through said rotatable drive hub.

6. The fluid powered spray device of claim 5, wherein said second body includes an agent reservoir configured to disperse an agent into the path of fluid dispersed from said fluid jets.

7. The fluid powered spray device of claim 6, wherein said turbine is configured with a sun gear to couple to said transmission.

8. The fluid powered spray device of claim 7, wherein said accessories are configured to evacuate the fluid expelled from said exit ports.

9. The fluid powered spray device of claim 8, wherein said detachable accessories are configured with a concentric contour.

10. The fluid powered spray device of claim 9, wherein said control valves can be locked into the open position and released to the normally closed position.

11. The fluid powered spray device of claim 10, wherein said control valves can be operated while said second body is rotated about said first body.

12. The fluid powered spray device of claim 11, wherein said second body rotates about said first body in a range of three hundred and sixty degrees.

13. The fluid powered spray device of claim 12, wherein said first body includes a rubberized grip.

14. A fluid powered spray device comprising:
a first body configured to be held by the hand of a user;
a second body rotatably coupled to said first body;
a plurality of fluid channels extending from said first body to said second body;
a plurality of control valves in said first body controlling the delivery of fluid to said fluid channels;
a nozzle in said second body dispersing fluid from one of said fluid channels;
a plurality of fluid jets in said second body dispersing fluid delivered from one of said fluid channels;
a turbine in said second body configured to rotate after receiving fluid dispersed from said fluid jets;
a transmission in said second body, said transmission having a rotatable input and a rotating output, said input coupled to and rotated by said turbine;
a rotatable drive hub coupled to said rotating output, said drive hub having a plurality of fluid exit ports and configured to receive a plurality of detachable accessories; and
a plurality of accessories selectively attachable to said drive hub for rotation therewith.

15. The fluid powered spray device of claim 14 having a plurality of ramps in said second body, said ramps configured to expel fluid dispersed from said fluid jets away from said turbine and towards said fluid exit ports after said fluid is received by said turbine.

16. The fluid powered spray device of claim 15, wherein said accessories are configured with a concentric contour to evacuate the fluid expelled from said exit ports.

17. The fluid powered spray device of claim 16, wherein said fluid channel to said nozzle extends concentrically through said turbine, though said transmission and through said rotatable drive hub.

18. The fluid powered spray device of claim 17, wherein said first body is rotatably coupled to said second body with a rotating joint, said rotating joint being configured to couple the plurality of fluid channels in said first body to the plurality of fluid channels in said second body.

19. The fluid powered spray device of claim 18, wherein said second body rotates about said first body in a range of three hundred and sixty degrees.

20. The fluid powered spray device of claim 19, wherein said first body houses a fluid agent reservoir and said second body houses an agent inlet, an agent outlet and reservoir cap, said reservoir being configured to receive a fluid agent from said agent inlet coupled to said reservoir though one of said fluid channels extending from said second body to said first body and to disperse said fluid agent from said agent outlet coupled to said reservoir though one of said fluid channels extending from said first body to said second body into the fluid dispersed from said fluid jets when a user applies external pressure to said reservoir cap.
